(19) United States
(12) Patent Application Publication
(10) Pub. No.: US 2006/0151480 A1
(43) Pub. Date: Jul. 13, 2006

(54) Method for the production of dentures made of pressed ceramics in the field of dental technology; dental ceramic press furnace and muffle therefor

(76) Inventor: Kurt Zubler, Neu-Ulm (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/524,600

(22) PCT Filed: Aug. 14, 2003
(86) PCT No.: PCT/EP03/09051

§ 371 Date: Dec. 9, 2005

(30) Foreign Application Priority Data
Aug. 14, 2002 (DE) 102 37 982.3

(51) Int. Cl. H05B 6/10

(52) U.S. Cl. 219/635

(57) ABSTRACT

The aim of the invention is to simplify a method for the production of dentures made of pressed ceramics in the field of dental technology, comprising the following steps; producing a muffle, introducing the muffle into the dental ceramic press furnace, heating a ceramic pellet and pressing a press ceramic object. A free area (25) is formed on the base of the muffle (50), which allows thermal radiation to pass through. The invention also relates to a corresponding dental ceramic press furnace and an associated muffle.

The present invention relates to a method for the production of dentures made of pressed ceramics in the field of dental technology, having the steps of producing a muffle, introducing the muffle into a ceramic press furnace, heating a ceramic pellet, and pressing a pressed ceramic object. Furthermore, the present invention relates to a ceramic press furnace and a muffle, particularly for performing the method according to the present invention.

In the production of dentures made of pressed ceramics, such as bridges, crowns, veneers, and inlays, a wax model of the object is produced first. This wax model is then embedded in a muffle, which becomes the muffle mold by assembling a muffle base, a muffle template, and a collar. In this case, the wax model is fixed on the muffle base using wax. Subsequently, embedding compound is poured into the prepared muffle mold. After the embedding compound has cured, the ring collar, the muffle template, and the muffle base are removed and the heat-resistant muffle is finished if necessary. Before the pressing procedure, the wax is first melted out and ceramic compound is introduced into the cavity thus arising (negative mold of the future dental technology object). For this purpose, after the wax is melted out, a ceramic pellet of the desired color and the required size is introduced into the ram channel of the press muffle and introduced together with the ram into the combustion chamber of the press furnace. After reaching the required pressing temperature, the actual pressing procedure is performed, in which the now free-flowing ceramic compound is pressed into the melted-out mold with the aid of the ram. This is an especially critical moment during production of the pressed ceramic object, since the ceramic is very temperature-sensitive, particularly if the press plate is not heated, as is typical in press furnaces, but rather heating coils are only provided in the upper part. Heat is therefore only supplied to the muffle around the circumference, so that the temperature falls toward the muffle floor. As a result of the falling temperature toward the muffle floor, the fluidity of the ceramic compound is reduced and it may possibly no longer sufficiently fill up the cavities. In commercially available press furnaces, it is therefore often necessary to enter a higher pressing temperature than that actually required, if the furnace manufacture has not already attempted to compensate for this with a discrepancy between input temperature and actual temperature.

Particularly for larger or angled objects, such as bridges, this means that the object may be imaged only incompletely or may be damaged through overheating. A requirement for the complete discharge of a mold is therefore a muffle which is completely and uniformly heated through. This means that the entire muffle, particularly in the region in which the objects lie, is to have a temperature which corresponds to the optimum pressing temperature before the pressing. The pressing procedure is therefore only to be performed if the required temperature exists uniformly in the region of the object molds and pressing channels within the muffle.

A suggested achievement of this object is described in DE 199 05 666, specifically a kiln, which, besides the typical upper heating coils, has an additional heating element in the floor plate, through which heat is also supplied to the muffle from the bottom side. In this way, uniform through heating and more rapid heating of the muffle are to occur. However, the increased construction outlay and the difficult measurement of the actual temperature in the muffle, which is necessary for precise regulation, are disadvantageous in this case.

The object of the present invention is therefore to provide a simplified method for producing pressed ceramic parts or objects in the field of dental technology, which avoids the disadvantages described above. Furthermore, a ceramic press furnace and a muffle are to be provided, particularly for performing this method.

This object is achieved by a method according to claim 1, a ceramic press furnace according to claim 5, and a muffle according to claim 8. Advantageous embodiments are the object of the subclaims.

The method according to the present invention for producing pressed ceramic objects in the field of dental technology is based on the following steps, which are already known from the related art: after a wax object is produced and embedded in a muffle, the muffle is introduced into a preheating furnace and the wax is melted out. After the ceramic compound, in the form of ceramic pellets, and the ram are introduced, muffle, ceramic pellet, and ram are heated in the press furnace. After the actual pressing procedure, the muffle is cooled with the ceramic object contained therein. According to the present invention, a free space transparent to thermal radiation (from the heating coils) is now formed in the floor region of the muffle, through which the floor region is heated through more uniformly, without using a complex floor heater. The thermal radiation is therefore conducted into the interior of the muffle and therefore into direct proximity with the object position, so that good fluidity of the ceramic compound is ensured there. Flaws of the ceramic object which may be attributed to insufficient fluidity of the ceramic compound and therefore to a pressing temperature which is too low are thus avoided.

Furthermore, it is advantageous that the heating time is shortened through the method according to the present invention, so that the time sequence during production of pressed ceramic objects in the field of dental technology may be optimized further. Unnecessary energy losses caused by heating rates which are too long are thus also avoided. Furthermore, overheating is avoided, which may lead to damage of the ceramic material and therefore to worsening of the surface quality or even to flawed pressings. Through the better access of the thermal radiation to the floor area of the muffle, the input temperature (setpoint) and the actual temperature correspond better in proximity to the ceramic objects. Therefore, precise and reliable temperature control is possible both when heating through different press muffle sizes and when firing ceramic in multifunction furnaces.

It is preferable in this case for the free space and/or small contact areas (stand feet) to be produced in one piece with the press muffle during testing of the embedding compound. If no reflecting body is used, the press muffle may additionally have a central stand foot or a protrusion in the form of a central pin on the floor in addition to the external stand feet. The thermal radiation of the heating coils reaches the central pin of the press muffle between the external stand feet and may thus be relayed into the center of the press muffle via the floor. Furthermore, the press plate of the ceramic press furnace is preferably implemented so that a thermal reflecting body is integrated or may be inserted. Through this thermal reflecting body in the form of a conical tip, the temperature distribution in the muffle placed thereon is equalized further. This conical tip preferably extends somewhat from the floor plate, so that it projects into the free space of the muffle.

Therefore, the thermal radiation coming from the side is reflected onto the floor of the muffle. Through the design of the press furnace according to the present invention in connection with the muffle according to the present invention, uniform temperature equalization is possible in the interior of the muffle and therefore in direct proximity to the object molds.

The muffle according to the present invention is particularly used for performing the method according to the present invention. In this case, the muffle has a free space having multiple platform-like piles on its lower face (opposite the press channel for inserting the ram and the ceramic pellet(s)). In this way, the thermal radiation may be conducted into the interior of the muffle, so that the temperature in direct proximity to the object(s) may be equalized. Through this advantageous design, the temperature within the muffle may also be kept largely constant in direct proximity to the press channels and the object molds.

To produce a muffle according to the present invention, a crown-shaped muffle template is employed, using which the free space may be molded into the muffle. After the embedding compound cures, the desired free space having the supporting piles remains, between which the thermal radiation may penetrate into the center of the floor region. In this case, a protrusion is preferably implemented in the center as the central pin in the floor area of the finished muffle, since in this way thermal radiation may also be incident directly and may be relayed into the muffle and/or its floor.

In the following, the present invention is to be explained in greater detail and described on the basis of the drawing.

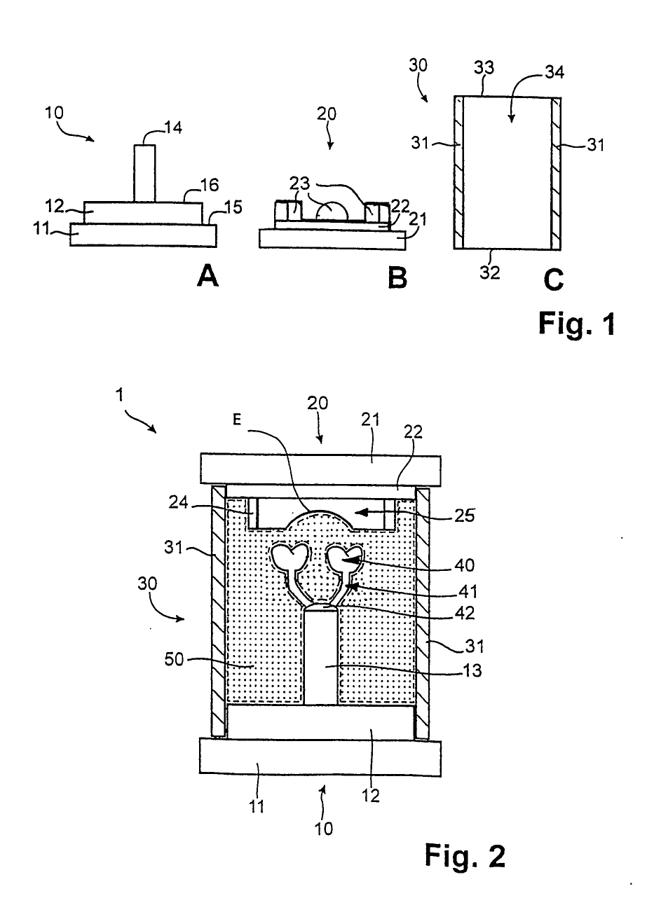

FIG. 1 shows the elements of a muffle mold in a front view and partially in section (C);

FIG. 2 shows a section through an assembled muffle mold;

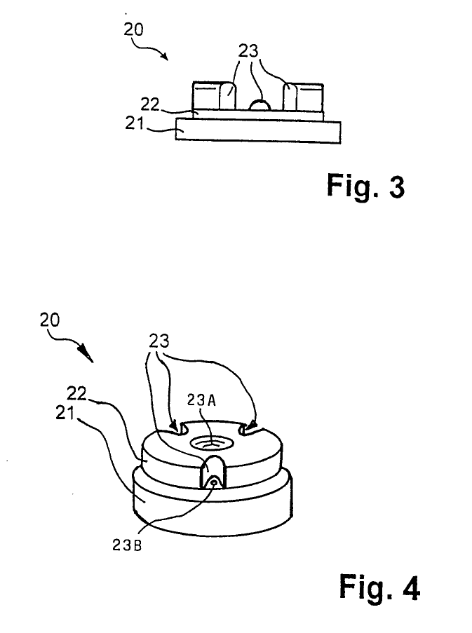

FIG. 3 shows an exemplary embodiment of an associated muffle template;

FIG. 4 shows a further exemplary embodiment of an associated muffle template in a perspective view;

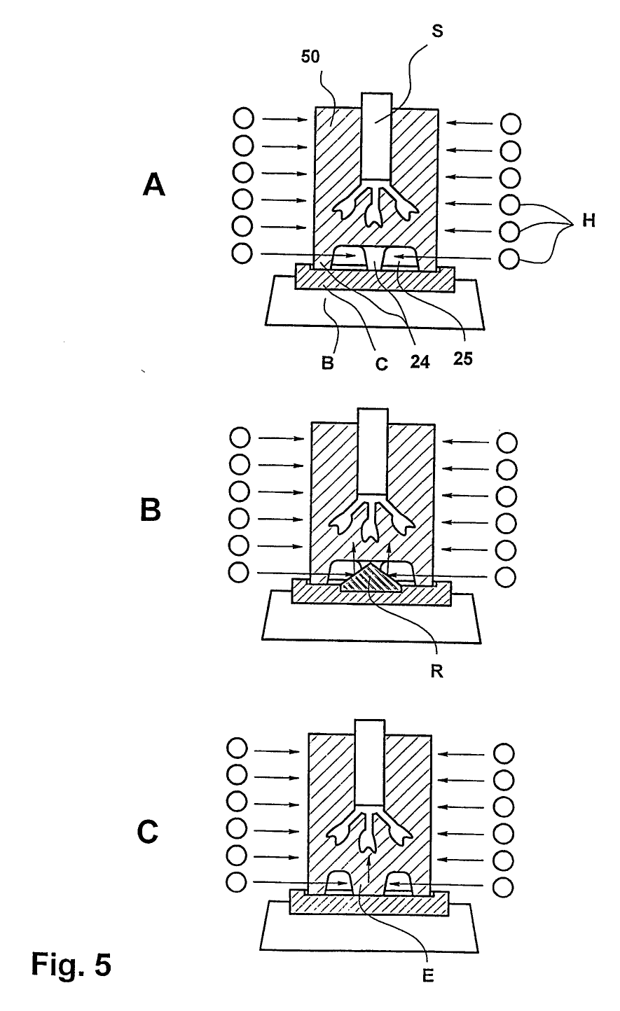

FIG. 5 shows a partial view of a combustion chamber of a ceramic press furnace according to the present invention with inserted muffle in three variations;

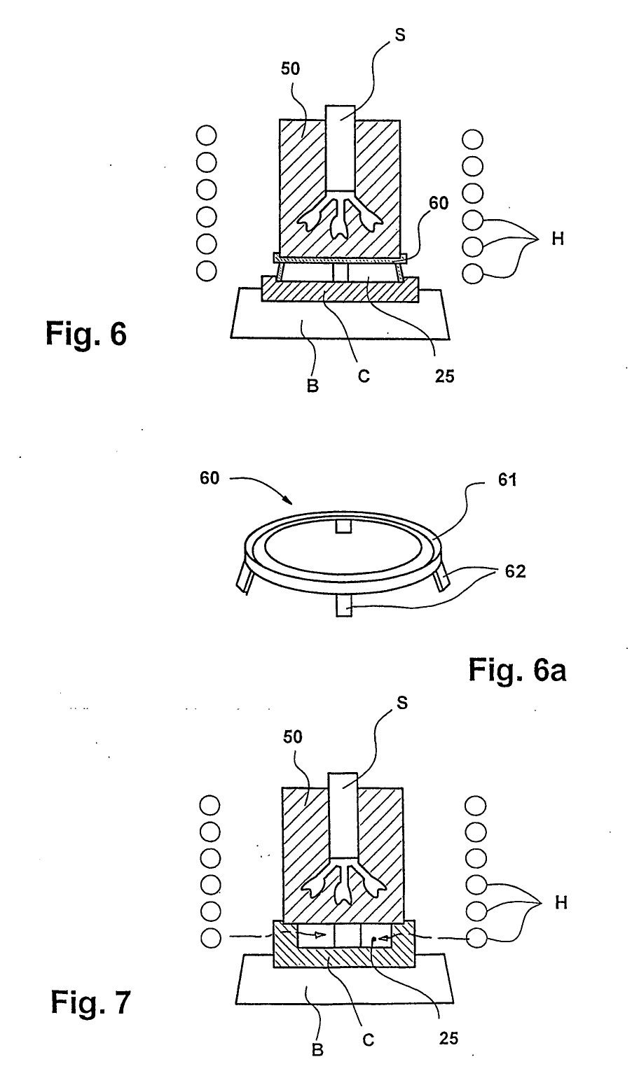

FIG. 6 shows an altered embodiment;

FIG. 6a shows a pedestal; and

FIG. 7 shows a further variation.

FIG. 1 schematically shows the individual elements of a muffle mold. A muffle base 10 is shown in FIG. 1A, a muffle template 20 is shown in FIG. 1B, and a section through a collar 30 is shown in FIG. 1C. The muffle base 10 comprises a floor ring 11, on whose contact surface 15 the collar 30 is placed. Furthermore, it has a muffle floor 12, whose top side 16 forms the face of the finished muffle. In addition, the muffle base 10 has a pin-shaped gate and/or ram channel 13 (more precisely: its negative shape as a spaceholder) (cf. FIG. 2). An accumulation area 14 is provided on the upper end of the ram channel 13, on which the wax objects are grown. The muffle template 20 (FIG. 1B) has a cover ring 21, whose annular area the collar 30 presses against. Furthermore, it has a volume 22 for displacing the embedding compound, whose surface images the floor of the later press muffle. The volume has multiple recesses 23 around its circumference. These recesses form the negative mold for the later piles or stand feet 24, which are provided to form the free space 25 between the floor of the press muffle and the press plate. To make unmolding the press muffle easier, the lateral surfaces of the recesses 23 are preferably implemented as conical. A recess 23 A is the negative mold for a later central pin E of the press muffle, which may possibly be provided. Associated holes 23 B are used for ventilation when filling the recesses 23. The surface of the volume 22 may also be implemented by protrusions shaped like spherical segments, which result in a vaulted structure on the floor of the press muffle in the positive mold.

The collar 30 is a rubber collar having a wall 31 in the exemplary embodiment of FIGS. 1 and 2. The lower edge 32 of the collar 30 is placed on the contact surface 15 of the muffle base 10. The muffle template 20 is then placed on the upper edge 33. The embedding compound is poured into the opening 34 of the muffle 30. Instead of a rubber collar, as in FIGS. 1 and 2, however, any other collar may also be used, particularly a paper collar while using a pouring ring (muffle ring).

FIG. 2 shows the muffle mold of FIG. 1 in the assembled state. The muffle mold 1, which is illustrated in section, thus comprises the elements muffle base 10, muffle template 20, and collar 30. The section through the muffle mold 1 also shows two models 40 fixed on the accumulation area 14 (cf. FIG. 1), each of which is fixed using a gate channel 41 to a wax heap 42. The muffle thus manufactured from embedding compound is indicated by a dashed line and dotted filling and identified with the reference number 50. This muffle 50 is then rotated by 180° and placed “upside down” in the ceramic press furnace illustrated in FIG. 5.

FIGS. 3 and 4 show altered exemplary embodiments of the muffle template 20. These muffle templates 20 each have, as already shown in FIG. 1, a cover ring 21 and muffle cover 22. Furthermore, web-shaped, preferably radially running protrusions 23 are provided, which image the particular recess for the piles or stand feet 24 and/or the central pin E in the muffle 50. In the exemplary embodiment of FIG. 3, the central protrusion 23 is implemented in the form of a rounded area, which then images the central protrusion E shown in FIG. 2 (cf. also FIG. 5C). The protrusions 23 in FIG. 4 have the form of truncated cones, which run radially inward from the circumference of the muffle cover 22, but only approximately a third of the radius, in order to image the piles 24 shown in FIG. 2 while leaving a free space 25. The number of protrusions provided may be tailored to the number of pressed objects, so that the temperature in the interior of the muffle 50 is equalized sufficiently precisely in proximity to the particular object, through which a more uniform and rapid heating through of the muffle also results. In addition, more than three recesses may also be provided. The shape of the recesses and therefore the shape of the protrusions and/or stand feet may also be selected largely arbitrarily, as long as an “air space” and/or free space 25 for the direct passage of the thermal radiation emitted by the heating coils H (cf. following FIG. 5) still remains on the floor region (in FIG. 2 still before the rotation onto the top side) of the muffle 50, as is indicated there with arrows to the central protrusion E.

FIG. 5 shows a detail from the combustion chamber of a ceramic press furnace in three variations. In FIG. 5A the arrows show the thermal radiation originating from the heating coils H, which reaches the free space 25 on the floor of the press muffle between the piles 24, and therefore ensures more rapid and uniform heating on the floor of the press muffle than if the entire area of the muffle was laid on the press plate B and/or an inlay C in the press plate B.

In FIG. 5B, a reflecting body R (made of quartz glass, for example) is additionally placed centrally under the floor of the press muffle. The thermal radiation is incident on the preferably conical reflecting body and is deflected upward to the floor of the press muffle, in the direction of the object cavity.

FIG. 5C shows the implementation in one piece of the press muffle with a central pin or central stand foot E. In this case, the thermal radiation is again incident between the external piles 24 directly on the central stand foot E. The heat supplied is relayed into the press muffle 50 originating from the stand foot E.

FIG. 6 shows a detail from the combustion chamber of a ceramic press furnace, the free space 25 under the floor of the muffle 50 being formed by a separate pedestal 60. The thermal radiation reaches the free space 25 as with implementation of the stand feet in one piece with the press muffle, as is indicated by an arrow.

FIG. 6a shows an exemplary embodiment of this pedestal 60 in a perspective illustration.

FIG. 7 shows a further detail from the combustion chamber of a ceramic press furnace, in which the pedestal is implemented by a special design of the press plate inlay. The free space 25 below the muffle 50 results in this case from smaller stand areas (protrusions) of the press plate and/or the inlay.

1. A method for the production of pressed ceramics in the field of dental technology, said method comprising:
providing a muffle having a free space which is transparent to thermal radiation in a floor region thereof,
introducing the muffle into a ceramic press furnace,
heating a ceramic pellet, and
pressing a pressed ceramic object.

2. The method according to claim 1, wherein the free space is implemented during the production of the muffle.

3. The method according to claim 1, wherein the free space is bordered by stand feet, which are particularly implemented in one piece with the muffle.

4. The method according to claim 1, wherein the muffle is placed centered on a press plate of the ceramic press furnace.

5. A ceramic press furnace, wherein a thermal reflecting body is integrated and/or inserted into the press plate or the free space is formed by designing the press plate or a press plate inlay having elevated stand feet.

6. The ceramic press furnace according to claim 5, wherein the thermal reflecting body has a conical shape.

7. The ceramic press furnace according to claim 5, wherein a muffle may be placed centered on the thermal reflecting body.

8. A muffle, wherein the muffle has a free space having multiple piles in its floor region.

9. The muffle according to claim 8, wherein a protustion, particularly in the form of a central pin, is positioned neighboring at least one press ceramic object.

10. The muffle according to claim 8, wherein the free space in the floor region of the muffle is implemented as vaulted.

11. The muffle according to claim 9, wherein multiple protrusions are implemented.

12. The muffle according to claim 8, wherein the free space is formed by a pedestal which may be laid below the muffle.
